(19) United States
(12) Patent Application Publication
(10) Pub. No.: US 2024/0248654 A1
(43) Pub. Date: Jul. 25, 2024

(54) CONTROLLING CONFIDENTIAL INFORMATION AT SHARED PRINTERS

(71) Applicant: International Business Machines Corporation, Armonk, NY (US)

(72) Inventors: Uri Kartoun, Cambridge, MA (US); Chaitanya Rao Challa, Chelmsford, MA (US); Shajeer K. Mohammed, Bangalore (IN); Tiberiu Suto, Franklin, NY (US)

(21) Appl. No.: 18/157,855

(22) Filed: Jan. 23, 2023

(51) Int. Cl. G06F 3/12

(52) U.S. Cl. CPC G06F 3/1222; G06F 3/1207; G06F 3/126; G06F 3/1292

(57) ABSTRACT

A computer-implemented method limits access to printed documents that include confidential data. The method includes receiving, by a print server, a request to print a first document, where the request is received from a user account associated with a user and the first document includes confidential information. The method also includes adding the first document in a print queue for a printer. The method further includes identifying a location of the user. The method includes determining, in response to the identifying the location of the user, the user is within a predetermined distance of the printer. The method also includes allowing, in response to the determining, the first printing device to print the first document. The method further includes printing the first document.

### BACKGROUND

The present disclosure relates to shared printers, and, more specifically, mobile technology to enhance security.

Shared printers are common in office buildings. The shared printers allow a large number of authorized users to use their computer to print content, including confidential content. Generally, the shared printer is located in a common area. In some scenarios, the printed materials are left unattended at the printer for a prolonged period of time.

### SUMMARY

Disclosed is a computer-implemented method to limit access to printed documents that may include confidential data. The method includes receiving, by a print server, a request to print a first document, wherein the request is received from a user account associated with a user and the first document includes confidential information. The method also includes adding the first document in a print queue for a printer. The method further includes identifying a location of the user; is within a predetermined distance of the printer. The method includes determining, in response to the identifying the location of the user, the user is within a predetermined distance of the printer. The method also includes allowing, in response to the determining, the first printing device to print the first document. The method further includes printing the first document. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for initiating dynamically switching between two access paths to prevent performance degradation during concurrent query processing, in accordance with some embodiments of the present disclosure.

FIG. 2 is a block diagram of a computing environment suitable for operation printing security manager, in accordance with one or more embodiments of the present disclosure.

FIG. 3 is a flow chart that illustrates an example method to limit printing of confidential information to when the user is within a predetermined distance of a printer, in accordance with one or more embodiments of the present disclosure.

FIG. 4 illustrates a flow chart of an example method to stop a print job when the user leaves the vicinity of a printer, in accordance with one or more embodiments of the present disclosure.

### DETAILED DESCRIPTION

The present disclosure relates to shared printers, and, more specifically, mobile technology to enhance security.

Shared printers are common in office buildings. The shared printers allow a large number of authorized users to use their computer to print content, including confidential content. Generally, the shared printer is located in a common area. In some scenarios, the printed materials are left unattended at the printer for a prolonged period of time. Although convenient and cost effective, shared printers can introduce or increase a risk that confidential of other sensitive data can be viewed, photographed, stolen, or otherwise accessed by unauthorized persons.

Computing environment 100 contains an example of an environment for the execution of at least some of the computer code involved in performing the inventive method, such as allowing printing of confidential documents when a user is within a predetermined distance of the printer in block 200. In addition to allowing printing of confidential documents when a user is within a predetermined distance of the printer in block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and allowing printing of confidential documents when a user is within a predetermined distance of the printer block 200, as identified above), peripheral device set 114 (including user interface (UI), device set 123, storage 124, and sensor set 125), and network module 115. Remote server 104 includes remote database 130. Public cloud 105 includes gateway 140, cloud orchestration module 141, host physical machine set 142, virtual machine set 143, and container set 144.

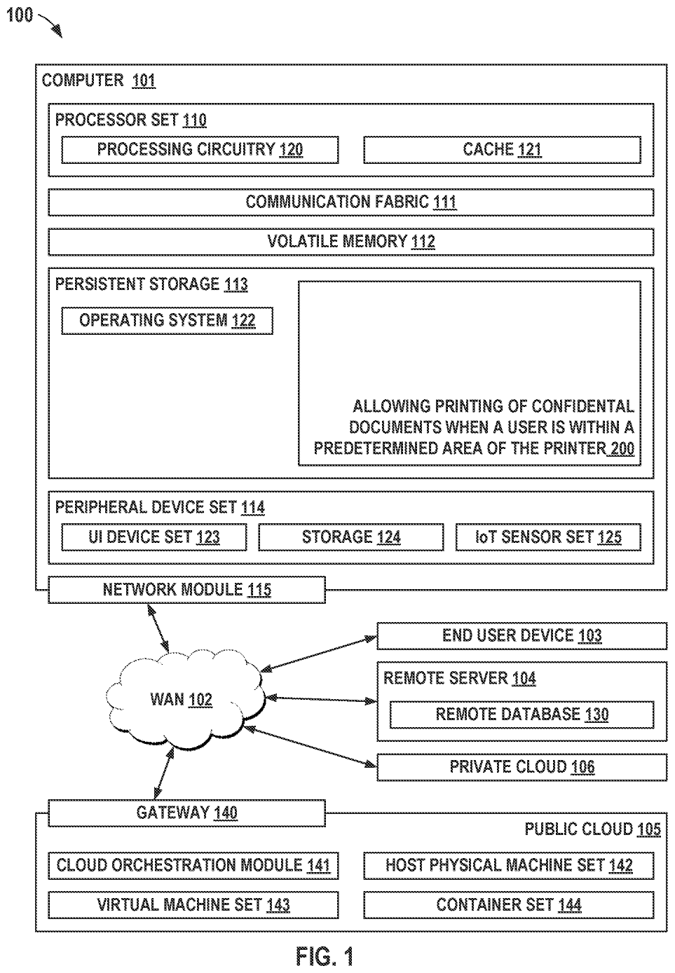

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. Performance of a computer-implemented method may be distributed among multiple computers and/or between multiple locations. On the other hand, in this presentation of computing environment 100, detailed discussion is focused on a single computer, specifically computer 101. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Sensor set 125 is made up of sensors that can be used in Internet of Things or other applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Shared printers are common in office buildings. The technology allows authorized users to use their computer to print content using a shared printer. Typically, a user uses his/her computer to send a print work to a dedicated printer-the content is printed once the user presents a registered badge located on a card reader attached to the printer. However, shared printers can lead to security vulnerabilities when the printed documents include confidential information.

In one example, a user may request a large print order (e.g., 50 pages). After the user provides proper credential to authorize printing (e.g., scan badge to the printer) he or she may then leave the printer while printing is in progress. In the user's absence the printed materials may be picked up, photographed, copied, or otherwise viewed by unauthorized parties (e.g., visitors, maintenance employees, colleagues). These innocent errors, even if by persons within a same company, can be a violation of laws and/or company policies.

Embodiments of the present disclosure can enhance document security by reducing the risk/likelihood of confidential information being accessed by unauthorized parties at a shared printer.

Embodiments of the present disclosure may include a security manager (or security module). In some embodiments, the security manager is configured to validate a user that requested a print job is within a vicinity of the printer. The security manager can prevent and/or stop printing of the current job based on identifying the location of the user.

In some embodiments, the security manager determines if the document(s) included in the print request contains confidential information. In some embodiments, the security manager determines the content of document is confidential by analyzing the content of the file. The analysis can be performed by a confidentiality analyzer. In some embodiments, the confidentiality manager can identify one or more types/instances of confidential information. Each type of confidential information can be correlated to one or more security parameters. In some embodiments, the user indicates a type of confidential information included when submitting/requesting the print job. In some embodiments, the type of file and/or name of the file can be a factor to determine if the documents include confidential information.

In some embodiments, the security manager will enable/start printing in response to determining the user is within a predetermined proximity of the printer. The security manager can determine a location of the user.

In some embodiments, the security manager determines the location of the user based on the user's phone (or portable computing device). The printer can use a short-wave limited distance connection to create a Personal Area Network (PAN), such as Bluetooth of Wi-Fi, to determine the location of the user. If the connection of the location of the user's phone is within a short proximity to the printer (e.g., not larger than 10 feet), then the security manager releases the print job. If the user leaves the vicinity of the printer (e.g., to the kitchen) then the security manager can stop the print job and send the user a notification. The notification can instruct/remind the user they have a print job in progress and to return to the printer.

In some embodiments, the security manager uses one or more Internet of Things (IoT) devices to identify the location of the user. The IoT devices can monitor for movement and/or sound and the like in the vicinity of the printer.

In some embodiments, the security manager can restrict access to documents already being printed by activating a lock of the output tray based on the confidentiality type. The restriction can be based on the location of the user.

The aforementioned advantages are example advantages, and embodiments exist that can contain all, some, or none of the aforementioned advantages while remaining within the spirit and scope of the present disclosure.

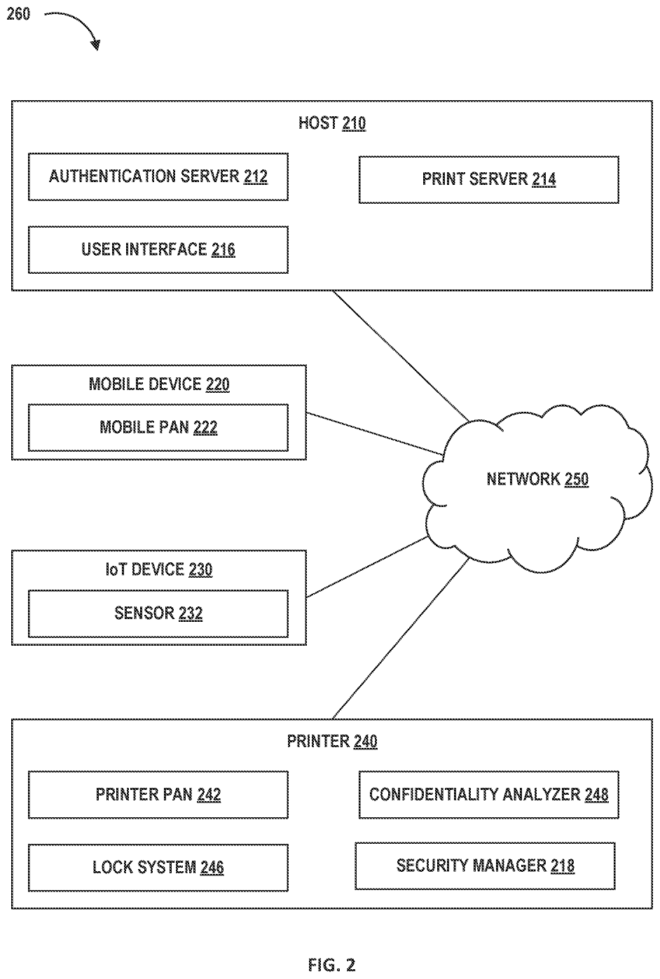

Referring now to various embodiments of the disclosure in more detail, FIG. 2 is a representation of a computing environment 260 that is capable allowing printing of confidential documents when a user is within a predetermined distance of the printer in block 200 of FIG. 1 in accordance with one or more embodiments of the present disclosure. Many modifications to the depicted environment may be made by those skilled in the art without departing from the scope of the disclosure.

Computing environment 260 includes host 210, mobile device 220, IoT Device 230, printer 240, and network 250. Host 210 can be consistent with computer 101 of FIG. 1. In some embodiments, Host 210, mobile device 220, IoT device 230, and printer 240 can be consistent with computer 101 of FIG. 1.

Network 250 can be, for example, a telecommunications network, a local area network (LAN), a wide area network (WAN), such as the Internet, or a combination of the three, and can include wired, wireless, or fiber optic connections. Network 250 may include one or more wired and/or wireless networks that are capable of receiving and transmitting data, voice, and/or video signals, including multimedia signals that include voice, data, and video information sent between and among host 210, mobile device 220, IoT device 230, printer 240 and other computing devices (not shown) within computing environment 260. In some embodiments, network 250 may be consistent with WAN 102 of FIG. 1. In some embodiments, network 250 can include two or more distinct networks. For example, one network can be an intranet/internet to allow for print jobs to be sent from mobile device 220, to host 210, and printed at printer 240, and a second network can be any PAN between mobile device 220 and printer 240.

Host 210 can be a standalone computing device, a management server, a web server, a mobile computing device, or any other electronic device or computing system capable of receiving, sending, and processing data. In some embodiments, host 210 can process one or more print jobs that are sent to printer 240. In various embodiments, host 210 can be a computing device such as a laptop or personal computer at a fixed location (e.g., workstation). Host 210 contains authentication server 212, user interface controller 216, and print server 214.

Authentication server 212 (or Authenticator) can be any combination of hardware and/or software configured to verify the identity of a user. In some embodiments, authentication server 212 determines whether the user (or the account the user is accessing) is authorized to perform a requested action or gain access to a device. For example, printer 240 can require authentication prior to creating and/or releasing a print job. In some embodiments, the authentication can be for any print job. In some embodiments, authentication can be for special print jobs. A special print job can be based on type of information (e.g., confidential, private, etc.) included in the print job, the size of the print job (e.g., over 50 pages), and/or any other designated category or combination of categories. In some embodiments, authentication server 212 can be a separate computing device and/or included in printer 240 and/or mobile device 220.

Print server 214 can be any combination of hardware and/or software configured to store requested print jobs. In some embodiments, print server 214 can receive a print request from host 210 and/or other computing devices. print server 214 can release the received print job to any printer in a printing network (e.g., printer 240). In some embodiments, print server 214 will only release a print job in response to a notification from security manager 218 and/or authentication server 212. The notification can indicate that all security standards are met prior to printer 240 initiating the print job. In some embodiments, print server 214 can be located within printer 240, and/or as a separate device within computing environment 200.

User interface controller 216 converts documents created in an application program of host 210 into a printer control language that can be interpreted in printer 240. The printer control language consists of commands that host 210 sends to printer 240 in order to instruct how printed copies are configured, and such commands manages font sizes, graphics, compression of data to be sent to printer 240. The print data converted by user interface controller 216 is temporarily contained in the print spooler and sent to the printer in the order stored in the printer spooler so that the print data is printed. In some embodiments, user interface controller 216 can provide an interface and/or be incorporated into one or more of host mobile device 220 and printer 240.

Mobile Device 220 can be any combination of hardware and software configured to provide a user access to a printing network. Mobile Device 220 includes mobile PAN 222. In some embodiments, mobile device 220 can request a print job. In some embodiments, mobile device 220 is configured such that printer 240 is automatically unlocked or locked when the user's mobile device 220 is proximate to a predetermined distance from printer 240. This is a wireless connection without any manual authentication or physical interaction with the host 210 or printer 240. The wireless connection can be based on mobile PAN 222 connecting to printer PAN 252. The connection can be used to determine a location of mobile device 220. In some embodiments, the connection represents that mobile device 220 is within a predetermined/prespecified distance of printer 240.

Mobile PAN 222 can be any combination of hardware and/or software configured to create a personal area network (PAN) within computing environment 260. The PAN can be any short range wireless communication method such as Bluetooth. In some embodiments, the PAN can communicate with printer 240. Mobile PAN 222 can also include optionally providing real-time notification of the pause to the print order, e.g., via e-mail or instant messenger, etc. In some embodiments, if an unauthorized user tries to access the printed documents, a warning notification is sent to the appropriate security personnel to handle the unauthorized access.

IoT device 230 can be any combination of hardware and/or software configured to identify a location of a user within an area around printer 240. In some embodiments, IoT device 230 can represent two or more separate IoT devices. Each of IoT device 230 can have one or more sensors 232 configured to and identify the location within the home. The sensor can include cameras, heat sensors, motion detectors, and the like. In some embodiments, IoT device 230 continues network signals to determine the location. For example, IoT device 230 determines a local network connection and can correlate that connection point to a room. The room can be the room where printer 240 is located or a different room. The location data can be shared with security manager 218 and/or printer 240.

In some embodiments, IoT device 230 may include computerized devices, such as personal computers, smartphones, servers, or the like. Two such devices may be networked together when one device is able to exchange information with the other device, whether or not they have a direct connection to each other. Two such devices may exchange data with each other using Network 250.

Printer 240 can be any combination of hardware and/or software configured to print physical copies of digital documents. In some embodiments, printer 240 can receive print information from print server 214 and generate physical documents from the print data. In some embodiments, computing environment can include one or more of printer 240. In some embodiments, printer 240 includes printer PAN 252, Lock system 256, confidentiality analyzer 258, and Security manager 218.

Printer PAN 252 can generate a network-connection between mobile device 220 and printer 240. In some embodiments, the network connection is a PAN and/or is an independent connection outside of network 250. The network connection can allow for sending and receiving of data between the connected devices. In some embodiments, printer PAN 252 is able to communicate with mobile PAN 222. Printer PAN 252 can detect when mobile PAN 222 is no longer present in the vicinity of printer 240 or has been moved a distance away. In some embodiments, Bluetooth 252 can be in an input to security manager 218. The input can assist security manager 218 in determining if it is appropriate to print a document. The input can include location data, distance from printer 240, and the like. Printer PAN 252 will monitor the location of mobile PAN 222 on the user's mobile device to unlock the print job.

Lock system 256 can be any combination of hardware and/or software configured to physically secure printed documents. In some embodiments, lock system 256 may be activated by Security Manager 218 and/or printer 240. The activation can be in response to determining the user is unauthorized and/or not in close proximity to printer 240. This can be based on confidentiality status of the print job. In some embodiments Lock System 256 is automatically locked when it is determined the user is not within the predetermined distance of printer 240. The distance can be based on a connection between mobile PAN 222 and printer PAN 252 and/or inputs from one or more IoT device 230. In some embodiments, lock system 256 can unlock/release the physical security in response to determining the user is in the vicinity of printer 240. In some embodiments, the mechanism to unlock Lock System 256 can be by entering a passcode, swiping a badge, and/or the location determination as described above.

Confidentiality analyzer 258 can be any combination of hardware and/or software configured to identify confidential information in a print request/print job. In some embodiments, confidentiality analyzer 258 uses data with the print job to determine the file contains confidential information (e.g., user checks a box indicating confidential, file type can indicate confidential, etc.). In some embodiments, confidentiality analyzer 258 can scan the data to identify confidential information. The scan can use one or more learning models and/or word finders to identify confidential information. In some embodiments, the determination of confidential information can prevent printing unless the release conditions (e.g., proximity, additional authentication, etc.) are met.

Security manager 218 determines whether the user, or the account the user is accessing, is authorized to perform a requested action or gain access to a device. In some embodiments, the action includes printing a document. Security manager 218 can ensure a set of requirements are satisfied prior to initiating, completing, or allowing pickup of a printed document. In some embodiments, security manager 218 determines if a document includes confidential information. A document can be determined to include confidential information based on an input from confidentiality analyzer 258, as a setting from an application, and/or a user requesting a print job.

In some embodiments, Security Manager 218 will automatically enter a locked mode if the user is not authorized or not in the vicinity. Security Manager 218 is configured such that Lock System 256 is automatically locked when Bluetooth 222 is not proximate to a predetermined distance from printer PAN 252. In some embodiments, Security manager 218 can provide a warning notification to the appropriate security personnel to handle the unauthorized access.

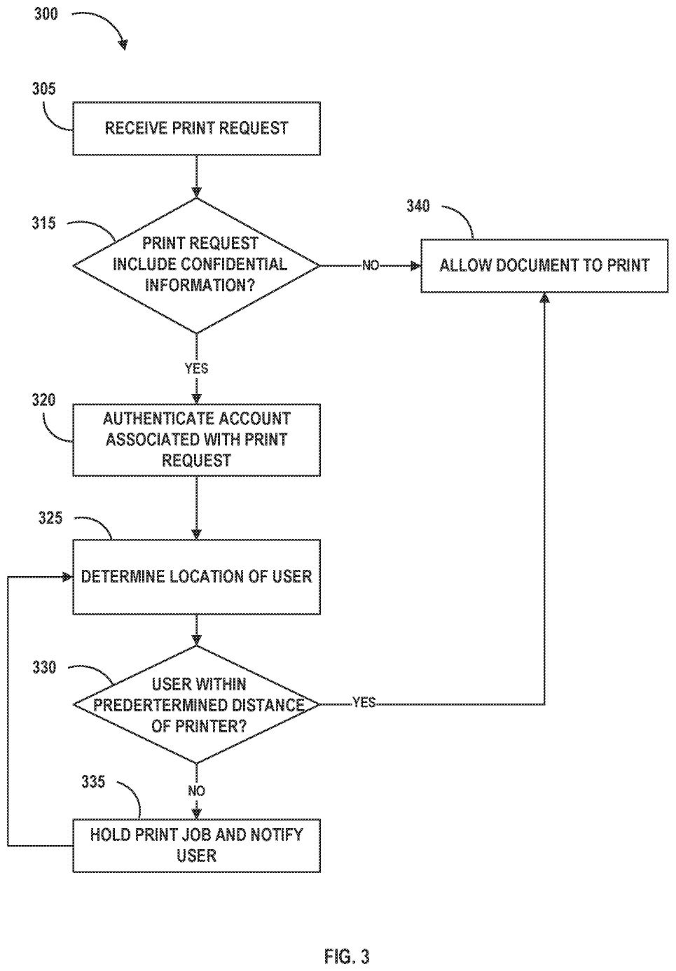

FIG. 3 depicts an example method, method 300, for determining a user is in the vicinity of a printer before printing confidential information in a common print area (e.g., computing environment 100 and/or computing environment 260). One or more of the advantages and improvements described above for initiating unplanned interactions/conversations may be realized by method 300, consistent with various embodiments of the present disclosure.

Method 300 can be implemented by one or more processors, host 210, authentication server 212, print server 214, user interface controller 216, mobile device 220, IoT device 230, printer 240, confidentiality analyzer 248, lock system 246, security manager 218, and/or a different combination of hardware and/or software. In various embodiments, the various operations of method 300 are performed by one or more host 210, authentication server 212, print server 214, user interface controller 216, mobile device 220, IoT device 230, printer 240, confidentiality analyzer 248, lock system 246, and/or security manager 218. For illustrative purposes, the method 300 will be described as being performed by security manager 218.

Security manager 218 receives a print job at operation 305. The print job can be sent to print server 214 and/or printer 240 to await release/permission to print by security manager 218. In some embodiments, the print job is configured to print a physical copy of a document. In some embodiments, the print job is associated with and/or received from one or more users and/or one or more user accounts. The user can authenticate that they are associated with a specific user account to gain access to printer 240 and/or print server 214. The print job can include all data needed to fully produce physical documents.

Security manager 218 determines if the print request includes confidential information at operation 315. Any document that contains any confidential information can be a confidential document. In some embodiments, the determination is based on data received with the print request. For example, a user may indicate (e.g., via a checkbox) that a document includes confidential information. The check box can be a prompt shown to the user in response to requesting a print job, and or a selectable option available with a printing application interface.

In some embodiments, the determination is based on analyzing data associated with the print job. Security manager 218 can analyze a document to determine if it contains confidential data. The analysis can be performed by confidentiality analyzer 248. In some embodiments, confidentiality analyzer 248 uses the content of the print job and/or file names of the print job to automatically assign or mark a document as confidential. If it is determined the document does not contain confidential data, then security manager 218 will proceed to operation 340. If it is determined the print request/document does contain confidential data (315: YES), then security manager 218 proceeds to operation 320. If it is determined the print request/document does not contain confidential data (315: NO), then security manager 218 proceeds to operation 340.

Security manager 218 authenticates the user/user account at operation 320. In some embodiments, authentication occurs at printer 240. The authentication can be any process that signals that the user is associated with the user account that requested the print job. The authentication can use manual, badge, password, and/or other similar methods. In some embodiments, the authentication occurs prior to receiving the print job and/or after the determination of confidential information.

Security manager 218 determines a location of the user at operation 325. In some embodiments, the location is based on a short-range connection between the printer and a device associated with the user. The short-range connection can be used to determine the location, and/or the connection can only occur if the user is within a predetermined distance. (e.g., the connection cannot occur if the mobile device is greater than 10 feet from the printer). For example, mobile PAN 222 can connect with printer PAN 242. The connection can indicate the authenticated user is within a predetermined distance of printer 240. In some embodiments, the location is based on IoT device 230.

In some embodiments, the location is determined by one or more IoT devices 230. Various sensor IoT devices can be used to determine the location of a user. Cameras, motion detections, badge readers, heat sensors, and the like can all be used. The determined location can be sent to security manager 218. In some embodiments, security manager 218 can use a combination of the PAN and the IoT devices 230 to determine the location of the user. For example, the PAN can be used to identify an individual in the area, and then an IoT device to track movement in the area.

Security Manager 218 determines if the user is within a predetermined distance from the printer at operation 330. In some embodiments, the distance is based on the location determined in operation 325. The distance can be a measured/calculated distance based on the location of the printer 240 and the determined location of the user. The predetermined distance can be any distance. It can be a set amount (e.g., ten feet), bounded by object (e.g., walls, cubes, etc.), based on a line of sight (e.g., 2 feet in one direction, and 15 feet in another direction). The locations withing the predetermined distance can be predefined for each printer. In some embodiments, the predetermined distance can be different based on the level/amount of confidential information. For example, confidential information can be high, medium, or low risk where high has the greatest consequences (or is the most important) if the data is lost/shared. Each level may have a different threshold. For example, high risk, can be 3 feet and no other person present, medium risk 8 feet, and low risk 20 feet. If it is determined the user is within the predetermined distance (325: YES), then security manager 218 proceeds to operation 340. If it is determined the user is not within the predetermined distance (325: NO), then security manager 218 proceeds to operation 335.

Security manager 218 holds the print job and notifies the user at operation 335. In some embodiments, the hold prevents printer 240 from producing the document. In some embodiments, the user is notified the print job cannot proceed until they are within the predetermined distance. The notification can be sent to mobile device 220 associated with the user via network 250.

Security manager 218 allows the document to be printed at operation 340. In some embodiments, security manager 218 can release a hold in the print job. This allows printer 240 to produce the document per the data in the print request.

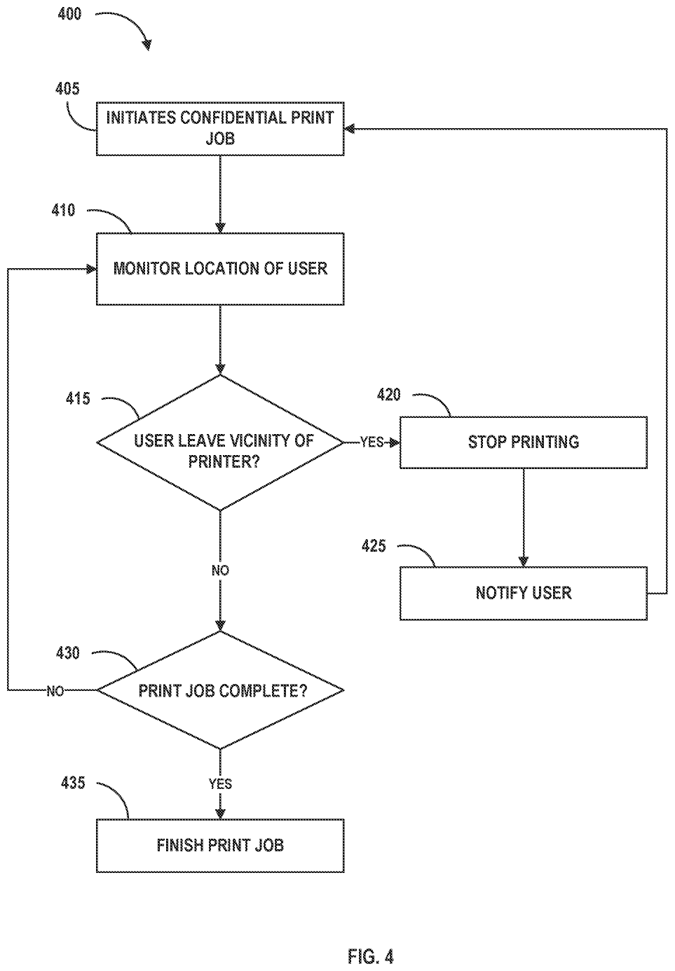

FIG. 4 depicts an example method, method 400, for stopping/securing an in-progress print job based on a user's location within a common print area (e.g., computing environment 100 and/or computing environment 260). One or more of the advantages and improvements described or stopping/securing an in-progress print job based on a user's location within a common print area may be realized by method 400, consistent with various embodiments of the present disclosure.

Method 400 can be implemented by one or more processors, host 210, authentication server 212, print server 214, user interface controller 216, mobile device 220, IoT device 230, printer 240, confidentiality analyzer 248, lock system 246, security manager 218, and/or a different combination of hardware and/or software. In various embodiments, the various operations of method 300 are performed by one or more host 210, authentication server 212, print server 214, user interface controller 216, mobile device 220, IoT device 230, printer 240, confidentiality analyzer 248, lock system 246, and/or security manager 218. For illustrative purposes, the method 400 will be described as being performed by security manager 218.

The security manager 218, initiates/starts a confidential print job at operation 405. The print job can be any print job where the printer has been authorized to start generating the physical documents. In some embodiments, operation 405 can be consistent with operations 305, 315, 320, 325, 330, and 340 of FIG. 3.

Security manager 218 monitors a location of a user at operation 410. The location can be determined by one or more of a PAN, one or more authentication mechanisms, and one or more IoT devices 230. In some embodiments, operation 410 is consistent with operations 325 and 330 of FIG. 3.

Security manager 218 determines if the user leaves the vicinity of the printer in operation 415. The vicinity can be the predetermined distance as described in operation 330. Whenever the user exceeds the predetermined distance, then the user can be considered to leave the vicinity of the printer. If it is determined the user does leave the vicinity of the printer (415: YES), then security manager 218 proceeds to operation 420. If it is determined the user does not leave the vicinity of the printer (415: NO), then security manager 218 proceeds to operation 430.

Security manager 218 stops printing at operation 420. In some embodiments, the stopping includes preventing any additional pages from being produces. In some embodiments, the stopping includes monitoring the printer with one or more IoT device 230. The monitoring can be used to determine if an unauthorized party gained access to printed materials.

In some embodiments, operation 420 includes locking any printed pages. Printer 240 can include a lockable area where confidential documents are produced. The locking mechanism can be engaged in response to the determination the user left the vicinity of the printer. The lock can prevent any person other than the requestor from unlocking the area, thereby keeping the documents secure. In some embodiments, the locking mechanism can remain locked until proper authentication is received by the printer (e.g., authentication server 212).

Security manager 218 notifies the user at operation 425. In some embodiments, the notification is sent to a mobile device (e.g., mobile device 420) associated with the user. The notification can be visual, haptic, and/or audible. The notification can be configured to prompt the user to return to the printer. After notifying the user, security manager 218 returns to operation 405. Once the user returns to the vicinity of the printer, printing can resume after verifying all conditions needed to initiate the print job are satisfied.

Security manager 218 determines if the print job is complete at operation 430. In some embodiments, the print job is complete if all pages and/or all copies of the pages have been produced. In some embodiments, the print job is determined to be complete only when the user is in the vicinity of the printer. In some embodiments, operation 430 includes unlocking lock system 246. The unlocking can be based on all pages being printed and/or the location of the user. Also, the unlocking can be based on authentication by the user. If it is determined the print job is complete (430: YES), then security manager 218 proceeds to operation 435. If it is determined the print job is not complete (430: NO), then security manager 218 returns to operation 410.

Security manager 218 finishes the print job at operation 430. In some embodiments, finishing the print job includes printing all pages and removing the print job from print server 214. In some embodiments, finished the print job includes determining the printed documents have been removed from the printer. This can be accomplished by one or more sensors on the printer, by IoT device 230, and/or by input from a user indication the print job is complete.

Embodiments of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A computer-implemented method, comprising:
receiving, by a print server, a request to print a first document, wherein the request is received from a user account associated with a user and the first document includes confidential information;
adding the first document in a print queue for a printer;
identifying a location of the user;
determining, in response to the identifying the location of the user, the user is within the predetermined distance of the printer;
allowing, in response to the determining, the printer to print the first document; and
printing the first document.

2. The computer-implemented method of claim 1, wherein the identifying the location of the user comprises:
connecting, by a personal area network (PAN), the printer with a mobile computing device associated with the user, wherein the identifying the location is based on the connecting.

3. The computer-implemented method of claim 2, wherein the PAN determines a distance of the mobile computing device from the printer.

4. The computer-implemented method of claim 1, wherein the identifying the location of the user is based on an input from one or more Internet of Things (IoT) devices.

5. The computer-implemented method of claim 2, further comprising:
initiating, by the printer, the print request;
identifying a second location of the mobile computing device at a later time;
determining, based on the second distance, the mobile computing device is outside the predetermined distance; and
stopping, in response to the determining the mobile computing device is outside the predetermined distance, the print request.

6. The computer-implemented method of claim 5, wherein the printer includes a locking mechanism configured to secure a printed document, the method further comprising:
locking, in response to the determining the mobile computing device is outside the predetermined distance, the locking mechanism that contains a portion of the first print job.

7. The computer-implemented method of claim 6, further comprising:
receiving, from an authenticator, an indication the user is present at the printer; and
unlocking, in response to the receiving the indication, the locking mechanism.

8. The computer-implemented method of claim 5, further comprising:
sending, in response to the stopping, a notification to the remote computing device, wherein the indication notifies the user of the stopping.

9. The computer-implemented method of claim 8, further comprising:
identifying a third location of the mobile computing device;
determining, in response to the identifying the third location, the third location is within the predetermined distance; and
resuming the printing.

10. The computer-implemented method of claim 1, further comprising:
determining the print request includes confidential information, wherein the determining is based on an input submitted with the print request.

11. The computer-implemented method of claim 1, further comprising:
determining the print request includes confidential information, wherein the determining is based on analyzing the print request with a learning model to identify the confidential information.

12. A system comprising:
a processor; and
a computer-readable storage medium communicatively coupled to the processor and storing program instructions which, when executed by the processor, are configured to cause the processor to:
receive, by a print server, a request to print a first document, wherein the request is received from a user account associated with a user and the first document includes confidential information;
add the first document in a print queue for a printer;
identify a location of the user;
determine, in response to the identifying the location of the user, the user is within a predetermined distance of the printer;
allow, in response to the determining, the first printing device to print the first document; and
print the first document.

13. The system of claim 12, wherein the identification of the location of the user comprises:
connecting, by a personal area network (PAN), the printer with a mobile computing device associated with the user, wherein the identifying the location is based on the connecting.

14. The system of claim 13, wherein the PAN determines a distance of the mobile computing device from the printer.

15. The system of claim 12, wherein the identifying the location of the user is based on an input from one or more Internet of Things (IoT) devices.

16. The system of claim 12, wherein the program instructions are further configured to cause the processor to:
determine the print request includes confidential information, wherein the determining is based on analyzing the print request with a learning model to identify the confidential information.

17. A computer program product, the computer program product comprising a computer readable storage medium having program instructions embodied therewith, the program instructions executable by a processing unit to cause the processing unit to:
receive, by a print server, a request to print a first document, wherein the request is received from a user account associated with a user and the first document includes confidential information;
add the first document in a print queue for a printer;
identify a location of the user;
determine, in response to the identifying the location of the user, the user is within a predetermined distance of the printer;
allow, in response to the determining, the first printing device to print the first document; and
print the first document.

18. The computer program product of claim 17, wherein the identification of the location of the user comprises:
connecting, by a personal area network (PAN), the printer with a mobile computing device associated with the user, wherein the identifying the location is based on the connecting.

19. The computer program product of claim 18, wherein the PAN determines a distance of the mobile computing device from the printer.

20. The computer program product of claim 17, wherein the identifying the location of the user is based on an input from one or more Internet of Things (IoT) devices.
